(19) United States
(12) Patent Application Publication
(10) Pub. No.: US 2020/0129010 A1
(43) Pub. Date: Apr. 30, 2020

(54) METHODS, SYSTEMS, AND APPARATUS FOR INTERFACING WITH MIXER DEVICES

(71) Applicant: Todd Alfred Voss, Ridgway, PA (US)

(72) Inventor: Todd Alfred Voss, Ridgway, PA (US)

(21) Appl. No.: 16/174,477

(22) Filed: Oct. 30, 2018

(51) Int. Cl. A47J 43/06; A47J 43/07; A21C 11/24; A47J 42/46; F16C 3/02; F16D 1/10

(52) U.S. Cl. CPC A47J 43/06; A47J 43/07; A21C 11/24; F16D 2001/102; F16C 3/02; F16D 1/10; A47J 42/46

(57) ABSTRACT

The presented apparatus relates generally to the ability to interface different devices and attachments to commercially available common-off-the-shelf (COTS) mixer devices. More particularly, the presented exemplary embodiment relates to methods, apparatus, and systems for the enablement of mating third-party products to the COTS mixing devices, utilizing the mixer as the drive source for the mated product. It will also provide for the transference of torque between the mixer and other third-party products.

### FIELD OF THE INVENTION

The presented apparatus relates generally to the ability to interface different devices and attachments to commercially available common-off-the-shelf (COTS) mixer devices. More particularly, the presented exemplary embodiment relates to methods, apparatus, and systems for the enablement of mating third-party products to the COTS mixing devices, utilizing the mixer as the drive source for the mated product. It will also provide for the transference of torque between the mixer and other third-party products.

### BACKGROUND

As described by Wikipedia, a mixer is defined as https://en.wikipedia.org/wiki/Mixer_(cooking):
“A mixer is a kitchen utensil which uses a gear-driven mechanism to rotate a set of beaters in a bowl containing the food to be prepared. It automates the repetitive tasks of stirring, whisking or beating. When the beaters are replaced by a dough hook, a mixer may also be used to knead.
A mixer may be a handheld mechanism known as an eggbeater, a handheld motorized beater, or a stand mixer. Stand mixers vary in size from small counter top models for home use to large capacity commercial machines. Stand mixers create the mixing action by rotating the mixing device vertically: planetary mixers, or by rotating the mixing container: spiral mixers.
Mixers for the kitchen first came into use midway through the nineteenth century; the earliest were mechanical devices. The demand from commercial bakers for large-scale uniform mixing resulted in the development of the electric stand mixer. Smaller counter-top stand mixers for home kitchen use soon followed . . . ”

### Furthermore:

The mixer with rotating parts was patented in 1856 by Baltimore, Md. tinner Ralph Collier. U.S. Pat. No. 16,267 This was followed by E. P. Griffith's whisk patented in England in 1857. Another hand-turned rotary egg beater was patented by J. F. and E. P. Monroe in 1859 in the US. U.S. Pat. No. 23,694 Their egg beater patent was one of the earliest bought up by the Dover Stamping Company, whose Dover egg beaters became a classic American brand. The Monroe design was also manufactured in England. In 1870, Turner Williams of Providence, R.I., invented another Dover egg beater model. U.S. Pat. No. 103,811
The first mixer with electric motor is thought to be the one invented by American Rufus Eastman in 1885. U.S. Pat. No. 330,829. The Hobart Manufacturing Company was an early manufacturer of large commercial mixers, and they say a new model introduced in 1914 played a key role in the mixer part of their business. The Hobart KitchenAid and Sunbeam Mixmaster (first produced 1910) were two very early US brands of electric mixer. Domestic electric mixers were rarely used before the 1920s, when they were adopted more widely for home use.

As one can see from the preceding text, mixing devices have had a long and illustrious history enabling consumers, individuals, or organizations to benefit from the uniform mixing of ingredients. These devices have become so popular over the years that according to the most recent research available on the Internet (http://www.housewares.org/pdf/mw/mw_v3n4.pdf), more than 79% of the US households own some sort of powered mixing device.

As part of the evolutions of these products, companies like KitchenAid and Cuisinart have realized that these devices can also be used as a source for driving other mechanical or electro-mechanical devices. Apparatus have been designed by these companies to drive attachments such as pasta makers, meat grinders, roto-slicer, shredder, etc. These additional apparatus let a user simplify as well as reduce the time required to accomplish many common chores, potentially eliminating much of the manual labor required to perform the task at hand.

While these attachments allow users to derive additional benefit from these mixing devices, there are a number of limitations with the existing technology. For one, if not all of the companies that provide mixer systems utilize a proprietary interface when attaching additional components to their base mixing system. This proprietary nature alone hampers the consumer's/customer's ability in a number of ways. For instance, if the base mixing system has become inoperable for some reason, the consumer is limited in their purchasing options. They would either have to purchase similar product from the same manufacturer or risk losing their investment in the additional components they may have purchased. Secondly, if a third-party and/or other mixing manufacturer offer a product not available from the original equipment manufacturer (OEM) of the customer's base mixer system, the customer is unable to avail themselves of the capabilities of the alternate manufacturer's devices. This is a bit ludicrous, especially when considering that a customer may own an already functional system to drive alternative devices. Additionally, the cost or quality differential between the proprietary devices provided by any given mixer manufacturer's design and other parties products could prove beneficial to the consumer.

Therefore, in light of the foregoing limitations, there is a long held desire for the development of the methods, apparatus, and systems that enable the interoperability of these additional or third-party attachments with a base mixing system. The foregoing disclosure of this document and attached documentation includes many details and specificities that enable interoperability between second/third-party attachments and apparatus to base mixing systems. While the embodiments disclosed within this document exemplify attaching to certain manufacturer's systems, many modifications to the embodiments described can be made without departing from the spirit and scope of the invention. It is to be understood that these have been presented for purposes of explanation only and are not to be interpreted as limitations of the present invention.

### DETAILED DESCRIPTION OF THE NON-LIMITING EXEMPLARY EMBODIMENT

The attached documents comprise disclosure or exemplary embodiments of the methods, apparatus, and system for enabling the use of commercially available common-off-the-shelf (COTS) mixers as the energy source for driving other machinery. The disclosed embodiments are exemplary only and are not meant to be limiting.

Overview

### BRIEF DESCRIPTIONS OF DRAWINGS

The following sections provide a high level overview of the features and functionality supported by the exemplary mixer system adapter embodiment. As previously discussed, there is a desire to enable alternative products to interface with base mixing systems. In one illustrative non-limiting embodiment, a base Kitchen Aid stand up mixer is representative of a potential drive system. An exemplary adapter plate is combined with the system to enable the attachment of a Cuccina Pro Pasta Maker as the alternative/third-party device to the drive system. The technology herein can be more fully understood by reading the following detailed description of the exemplary non-limiting embodiments together with the accompanying drawings, in which like reference indicators are used to designate like elements, and in which:

FIG. 1 is a schematic diagram depicting the base mixer, drive interface apparatus, and third-party attachment.

FIG. 2 is a schematic diagram depicting an alternate drive interface apparatus that provides for a multi-position drive interconnect.

FIG. 3 is an exemplary illustrative pictorial embodiment depicting a prototype adapter set.

FIG. 4 is an exemplary illustrative pictorial embodiment depicting a prototype drive pin mechanism in a latitudinal orientation showing length measurement.

FIG. 5 is an exemplary illustrative pictorial embodiment depicting a prototype drive pin mechanism latitudinally oriented showing KitchenAid key measurement.

FIG. 6 is an exemplary illustrative pictorial embodiment depicting a prototype drive pin mechanisms in a latitudinal orientation showing non-KitchenAid key measurement.

FIG. 7 is an exemplary illustrative pictorial embodiment depicting a side view of a prototype adapter type #1 showing drive pin inserted and measurement.

FIG. 8 is an exemplary illustrative pictorial embodiment depicting a top view of a prototype adapter type #1 showing drive pin removed and measurement.

FIG. 9 is an exemplary illustrative pictorial embodiment depicting a side view of a prototype adapter type #2 showing drive pin inserted and measurement.

FIG. 10 is an exemplary illustrative pictorial embodiment depicting a top view of a prototype adapter type #2 showing drive pin removed and measurement.

FIG. 11 is an exemplary illustrative pictorial embodiment depicting prototype drive pin mechanisms in a latitudinal orientation.

FIG. 12 is an exemplary illustrative pictorial embodiment depicting prototype drive pin mechanisms longitudinally oriented.

FIG. 13 is an exemplary illustrative pictorial embodiment depicting the KitchenAid Mixer accessory rectangular drive socket.

FIG. 14 is an exemplary illustrative pictorial embodiment depicting a KitchenAid Mixer accessory rectangular drive socket with an exemplary prototype drive pin inserted.

FIG. 15 is an exemplary illustrative pictorial embodiment depicting a Marcato pasta maker's keyed drive pin sockets.

FIG. 16 is an exemplary illustrative pictorial embodiment depicting a side view of a Marcato pasta maker with an exemplary prototype adapter type #1 attach and an exemplary prototype drive pin inserted in one of the pasta maker's drive pin sockets.

FIG. 17 is an exemplary illustrative pictorial embodiment depicting a top view of a Marcato pasta maker with an exemplary prototype adapter type #1 attach and an exemplary prototype drive pin inserted in one of the pasta maker's drive key sockets.

FIG. 18 is an exemplary illustrative pictorial embodiment depicting a side view of a Marcato pasta maker with an exemplary prototype adapter type #1 attach and an exemplary prototype drive pin removed from one of the pasta maker's drive pin sockets.

FIG. 19 is an exemplary illustrative pictorial embodiment depicting a side view of a Marcato pasta maker with an exemplary prototype adapter type #1 attach and an exemplary prototype drive pin inserted in one of the pasta maker's drive pin sockets and mounted to the KitchenAid mixer accessory drive socket.

FIG. 20 is an exemplary illustrative pictorial embodiment depicting a side view of an Atlas pasta maker with an exemplary prototype adapter type #2 attach and an exemplary prototype drive pin inserted in the pasta maker's drive pin socket.

FIG. 21 is an exemplary illustrative pictorial embodiment depicting an alternative side view of an Atlas pasta maker with an exemplary prototype adapter type #2 attach and an exemplary prototype drive pin inserted in the pasta maker's drive pin socket.

FIG. 22 is an exemplary illustrative pictorial embodiment depicting a front view of an Atlas pasta maker with an exemplary prototype adapter type #2 attach and an exemplary prototype drive pin inserted in the pasta maker's drive pin socket.

FIG. 23 is an exemplary illustrative pictorial embodiment depicting a front view of a combined Atlas and Marcato pasta maker with an exemplary hand crank inserted into one of the combined pasta maker's drive pin sockets.

FIG. 24 is an exemplary illustrative pictorial embodiment depicting a side view of a combined Atlas and Marcato pasta maker with an exemplary hand crank inserted into one of the combined pasta maker's drive pin sockets.

FIG. 25 is an exemplary illustrative pictorial embodiment depicting a side view of a combined Atlas and Marcato pasta maker with an exemplary hand crank inserted into another one of the combined pasta maker's drive pin sockets.

FIG. 26 is an exemplary illustrative pictorial embodiment depicting a side view of a combined Atlas and Marcato pasta maker with an exemplary hand crank inserted into yet another one of the combined pasta maker's drive pin sockets.

FIG. 27 is an exemplary illustrative pictorial embodiment depicting a side view of the Atlas and Marcato pasta maker exemplary hand crank.

FIG. 28 is an exemplary illustrative pictorial embodiment depicting a front view of the Atlas and Marcato pasta maker exemplary hand crank.

FIG. 29 is an exemplary illustrative pictorial embodiment depicting a side view of the Atlas and Marcato pasta maker with exemplary hand crank inserted into one of the combined pasta maker's drive pin sockets and the combined pasta maker mounted to an exemplary table with the supplied clamp.

FIG. 30 is an exemplary illustrative embodiment of an adapter system for a commonly available mixing system manufactured by Cuisinart

FIG. 31 is an illustrative pictorial representation of a commonly available meat grinder used in food preparation.

FIG. 32 is an non-limiting illustrative embodiment of a drive pin enabling the operative coupling of the at least one mixing system to the exemplary illustrative pictorial representation of a commonly available meat grinder in FIG. 31.

FIG. 33 is an illustrative pictorial representation of a commonly available grain grinder use in food and beverage preparation.

FIG. 34 is an illustrative pictorial representation of a commonly available coffee grinder use in food and beverage preparation.

FIG. 35 is an illustrative pictorial representation of a commonly available spiral slicer use in food and beverage preparation.

FIG. 36 is illustrative representation depicting an alternate drive interface assembly that operatively couples alternate devices to the base drive system that do not lend themselves to being supported by or placed within the proximity of the base drive system.

Over the past several years, food, along the home preparation of food has been significantly elevated in the social consciousness of the American public. Long past are the days where shows like the Galloping Gourmet (Graham Kerr) or The French Chef (Julia Child) are relegated to the bowels of daytime television programming on local TV or public broadcasting stations. Today there are entire networks and TV channels dedicated to the teaching of both the preparation and cooking of food. Today's most popular chefs are now household names, such as Emeril Lagasse or Masaharu Morimoto. Given this rise of “food” and its preparation in American psyche, there has been a dramatic rise in individuals wanting to prepare food from scratch instead of using manufactured store bought products. Not wanting to miss out on a large evolving marketplace, many traditional household goods manufacturers, along with entrepreneurs, have brought a plethora of gadgets to market to aid the consumer in their food preparation endeavors. However, as explained previously, many of these manufacturers and entrepreneurs have designed products and add-ons that are proprietary in nature, ultimately limiting consumer choice. To resolve at least part of this fundamental issue, one non-limiting exemplary embodiment of the present invention enable the interoperability between different manufacturers' products.

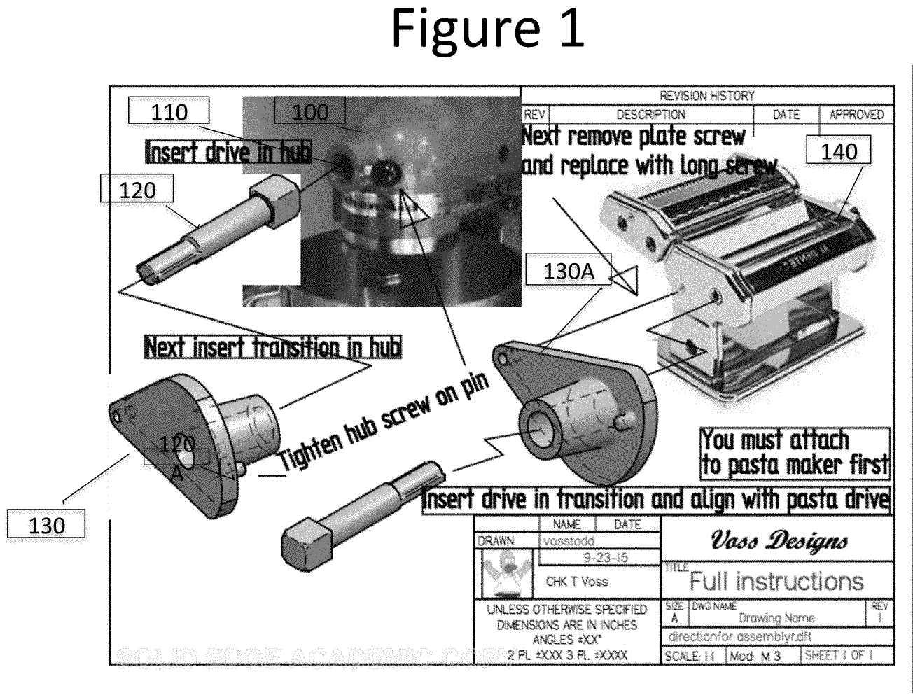

Referring to FIG. 1, it provides an exemplary non-limiting overview of how one may achieve interoperability between a KitchenAid Mixing system (100) and a CuccinaPro Pasta Maker (140). The KitchenAid Mixing system already provides the attachment of its proprietary accessories. Notice that at the top of the KitchenAid Mixer (100), a rectangular style drive receptacle is provided. Alternatively, the CuccinaPro Pasta Maker provides a keyed circular drive pin to enable its product to operate. Clearly this is an exemplary illustration of the proverbial problem of trying to mate rectangular peg into a round hole. Without the non-limiting, exemplary adapter apparatus (drive pin 120, and plate 130), the KitchenAid device (100) could not be mated with the CuccinaPro pasta maker system (140). In this non-limiting illustrative embodiment, the drive pin (120) is inserted into the KitchenAid Mixer's (100) drive receptacle (110). Next the adapter plate (130) is mated to the CuccinaPro Pasta making device (140). In this illustrative embodiment, the adapter plate (130) is secured to the CuccinaPro Pasta Maker device (140) by removing a plate screw and then fastening adapter plate (130) to device (140) by either using the same screw (if long enough) or using an alternate screw of sufficient length (not shown). Once the adapter plate (130) is securely fastened to the CuccinaPro Pasta Maker device (140), the adapter plate is then slid over drive pin (120), and the two systems are mated and secured by tightening the drive receptacle (110) screw. At this point the KitchenAid mixer system (100) can be turned on and will drive the CuccinaPro Pasta Maker device (140), potentially reducing the manual effort required to make pasta. Alternate view of the drive pin (120A) and the adapter plate (130A) shows the reverse corresponding exemplary non-limiting design required to mate to the proprietary devices. Other more complex or alternate arrangements can be easily envisioned by those schooled in the art without departing from the spirit of the invention.

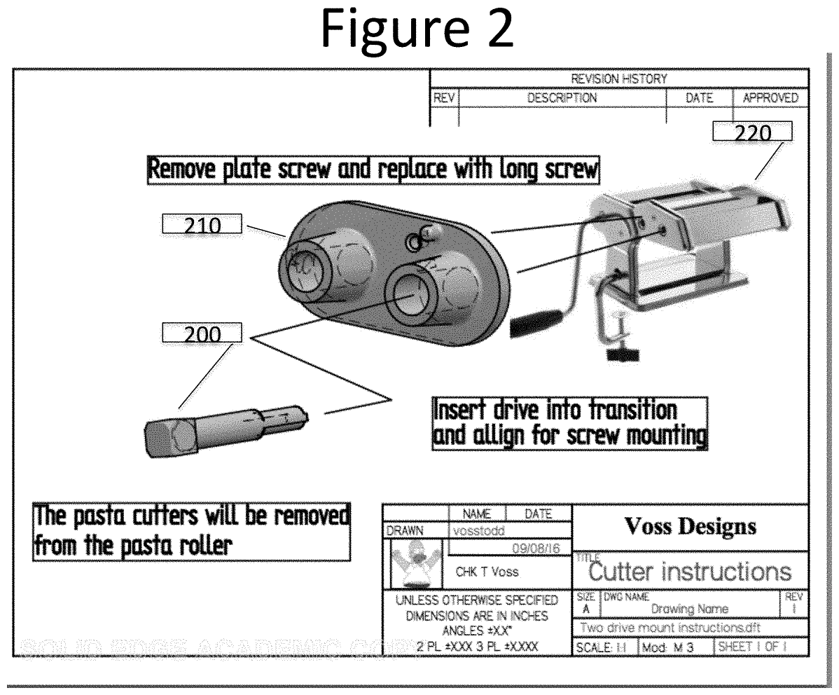

In another non-limiting illustrative embodiment, FIG. 2 provides a non-limiting illustrative embodiment, enabling the attachment to a third-party device that may have more than one drive attachment point. In FIG. 2, the KitchenAid mixer system of FIG. 1 (100) can be similarly attached to a different CuccinaPro Pasta Maker. In this case, the different drive points potentially allow for different shapes of pasta to be cut such as fettuccini versus spaghetti. Once again the drive pin (200) would be appropriately inserted into both the KitchenAid mixer system (100) and to the CuccinaPro Pasta Maker (220). Depending on what style of pasta the individual wishes to produce, the non-limiting exemplary adapter plate (210) would be correctly mated with the KitchenAid Mixer drive hub (110). Of course drive pin (200) would be inserted and mated through the correct orifice depending on the style of pasta selected.

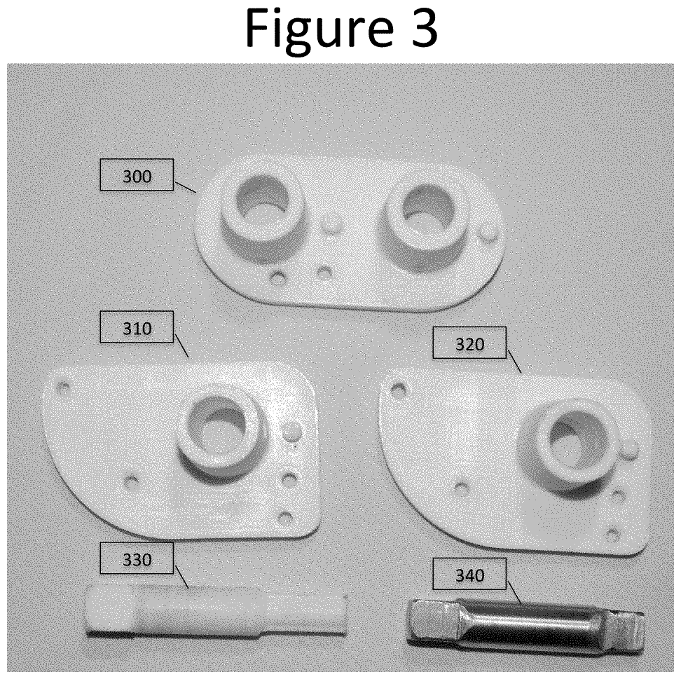

FIG. 3 depicts one non-limiting illustrative embodiment of different mating plate adapters (300, 310, 320) and drive pins (330, 340) to support different third-party attachments. These drive pins (330, 340) are used to assist in the operative coupling to and transfer of the drive motion created by the KitchenAid Mixer drive hub (110) of FIG. 1 to the at least one third-party accessory device. In one exemplary non-limiting embodiment, a drive pin (330, 340) comprises a roughly cylindrical structure having differently structured male or female projections on opposite distal ends. In one exemplary embodiment, the male projection on one end is rectangular in cross-section. The male projection on the opposite end is cylindrical with longitudinal spindle portions spaced about the circumference of the cylindrical outer surface. A central coupling portion between the two ends fixedly couples the two projections so they rotate together. In some embodiments, the coupling portion can be made of plastic to provide some degree of torsional flexibility. In other embodiments, the coupled portion can be made of metal such as steel or aluminum with limited torsional rotational movement permitted between the projections so that the projections turn nearly exactly together. Alternatively, the coupling portion might be a flexible cable composed of materials such as wound steel or thermoplastic polymer. Therefore the adapter can be of unitary construction or can be made of different components that are fitted or bonded together.

Similarly, in one non-limiting illustrative embodiment, the mating plate adapters (300, 310, 320) are designed to fixedly couple the KitchenAid Mixer system to the third-party attachment. The non-limiting illustrative mating plates (300, 310, 320) allows one side of the aforementioned drive pins to be inserted into the drive hub (110) of the KitchenAid Mixer and the other side to be inserted into the drive socket of a third-party attachment. The exemplary mating plate acts as support for the drive pins (330, 340) as well as at least one third-party attachment to ensure that each device is supported during the transfer of torque. In the shown non-limiting illustrative embodiment, one side of the mating plate is flat and is affixed to the third-party attachment potentially by bolt and nuts, clips, captive nuts, rivets, clamps, etc., or however best to affix the adapter plate as dictated by its design. Other mating plate form factors or cable attachments can be easily envisioned by those schooled in the art. The other side of the mating plates (300, 310, 320) has at least one cylindrical protrusion that fits into the well of the drive hub (110) of the KitchenAid Mixer. Once the cylindrical protrusion is inserted into the drive hub well (110), it is adhered into place by tightening the locking bolt on the outside of the drive hub well (110) of the KitchenAid Mixer. A registration nub is also present to further correctly align to mating plate inside the drive hub well (110).

Once the mating plate is locked down with the drive pin (330, 340) correctly inserted into the drive hub of the KitchenAid Mixer and the drive socket of the third-party attachment, the mixer can then be turned on to cause the electric motor to create the rotational motion. The torque created by the motor is then transferred through the drive pin (330, 340) from the KitchenAid Mixer to the third-party device. As in the case of the illustrative non-limiting exemplary mating plate (320), multiple protrusions can be present, each of which can be inserted into the drive hub well (110) based on the selection of what feature of the third-party attachment is to be used. The mating plate in some embodiments can be made of plastic to provide some degree of torsional or architectural flexibility. In other embodiments, the mating place portion can be made of metal such as steel or aluminum. Therefore the non-limiting illustrative mating plate can be of unitary construction or can be made of different components that are fitted or bonded together.

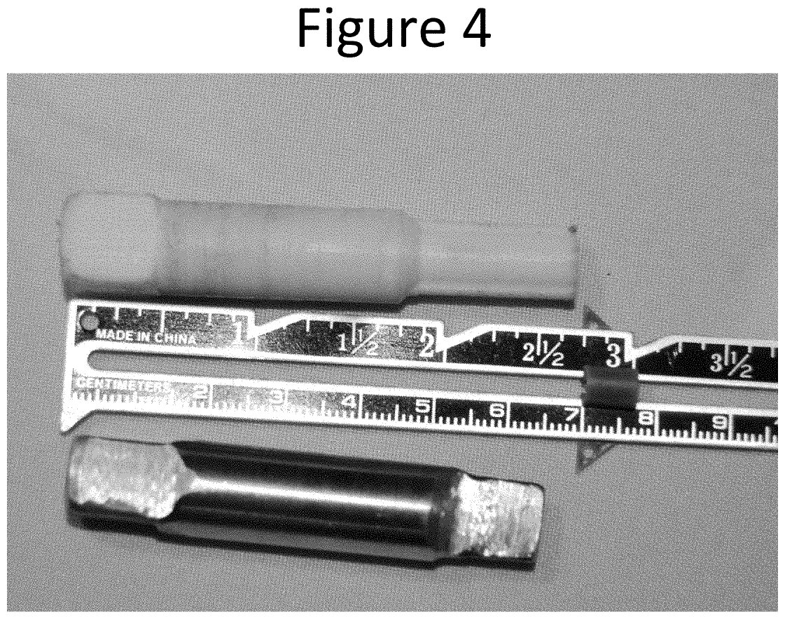

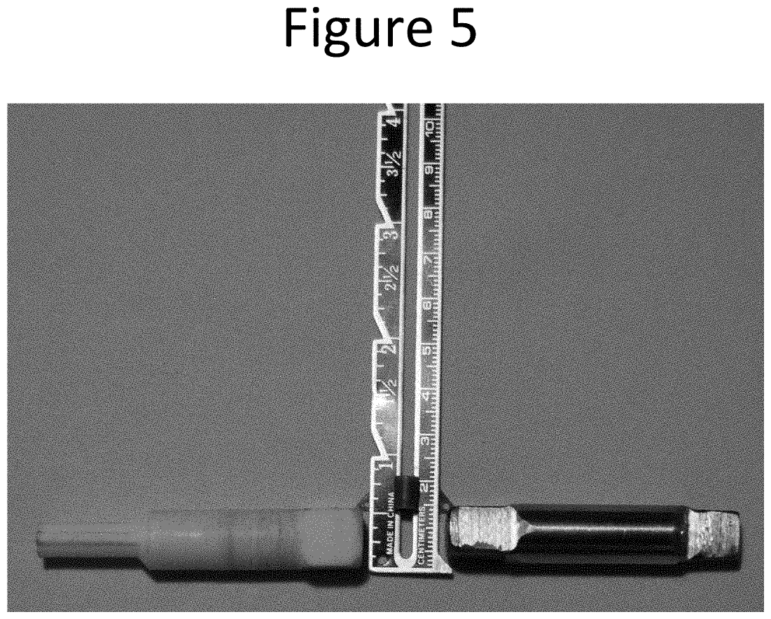

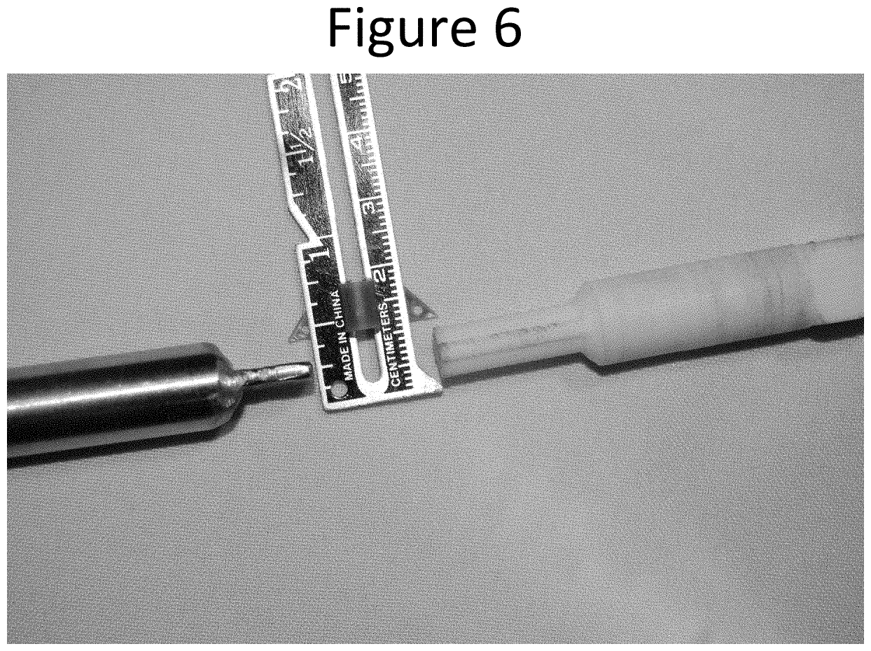

In this non-limiting illustrative embodiment, FIG. 4 shows that the length of the drive pins (330, 340) are approximately 65 to 70 millimeters (2.75 inches) in length. As one can see, the drive pins (330, 340) can be composed of different materials and formed to meet the requirements of both the KitchenAid Mixer drive hub (110) and the at least one third-party accessory being operatively coupled to the mixing unit. Other lengths and shapes can easily be envisioned by those schooled in the art. FIG. 5 is an alternative view of the non-limiting illustrative embodiment of the exemplary drive pins (330, 340) that can be inserted into the KitchenAid drive hub (110). FIG. 5 shows that the width dimensions of these non-limiting illustrative drive pins (330, 340) are approximately 13 millimeters (0.5 inch). FIG. 6 is alternative view of the non-limiting illustrative embodiment of the exemplary drive pins (330, 340) that are inserted into the drive socket of the at least one third-party accessory. Again, these non-limiting exemplary designs and tapers are representative that modification can be made without departing from the spirit of the preferred embodiment.

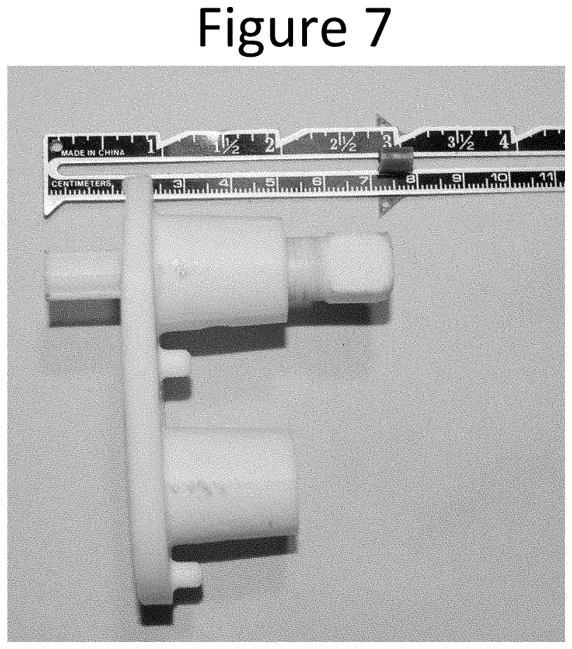

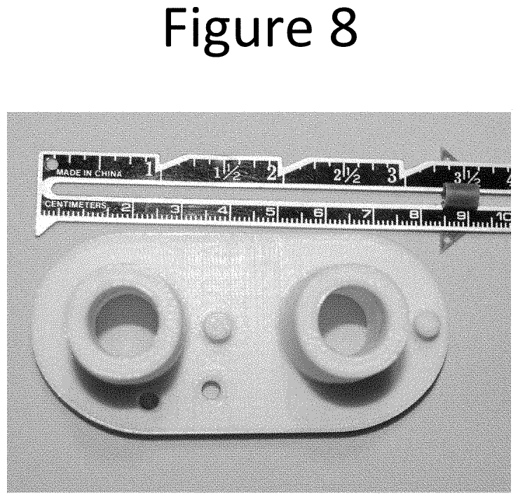

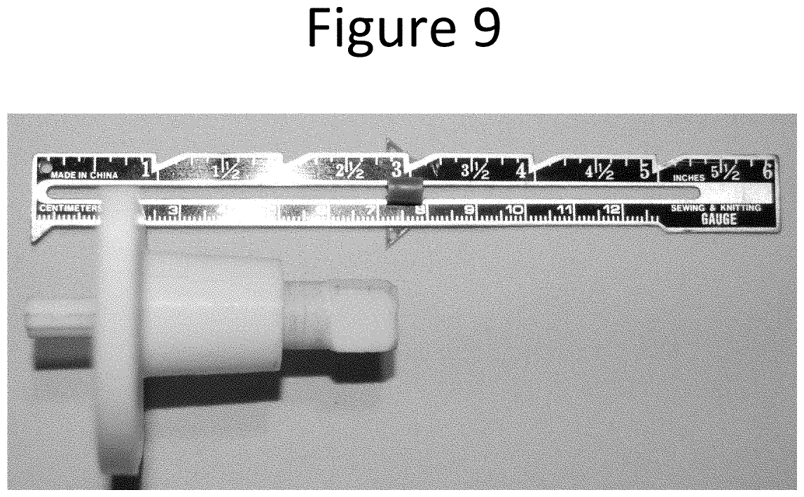

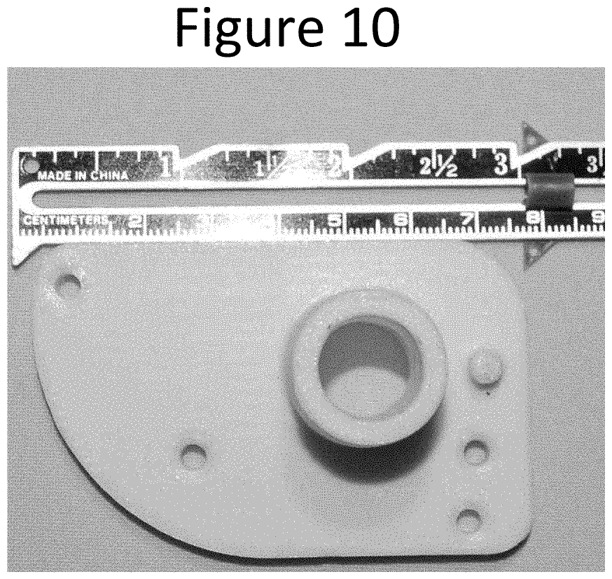

FIGS. 7 through 10 depict non-limiting illustrative embodiments of the mating adapter plates (300, 310, 320) that assist in the operative coupling of the at least one third-party accessory to the KitchenAid drive hub (110) of FIG. 1. In conjunction with the use of the non-limiting illustrative drive pins (330, 340), as depicted in FIGS. 4 through 6, the at least one third-party accessory can then be operated using the forces generated by the KitchenAid mixer (100). FIG. 7 is a side view of a non-limiting illustrative embodiment of an adapter mounting plate (300) with an exemplary drive pin (330) inserted. The width of this non-limiting illustrative adapter plate (300) with the pin inserted (330) is approximately 75 millimeters (2.9 inches). FIG. 8 depicts a top view of a non-limiting illustrative mating adapter plate (300) with a length of approximately 86 millimeters (3.4 inches). Notice in this illustrative embodiment there are multiple orifices for the drive pins (330, 340) to be inserted through, and multiple mounting holes and nubs that enables it to mate with different features of the at least one third-party accessory or version of the KitchenAid mixer (100). FIG. 9 is a side view of a second non-limiting illustrative embodiment of an adapter mounting plate (310) with an exemplary drive pin (330) inserted. The width of this non-limiting illustrative adapter plate (310) with the pin inserted (330) is approximately 75 millimeters (2.9 inches). FIG. 10 depicts a top view of the second non-limiting illustrative mating adapter plate (310) with a length of approximately 76 millimeters (2.9 inches).

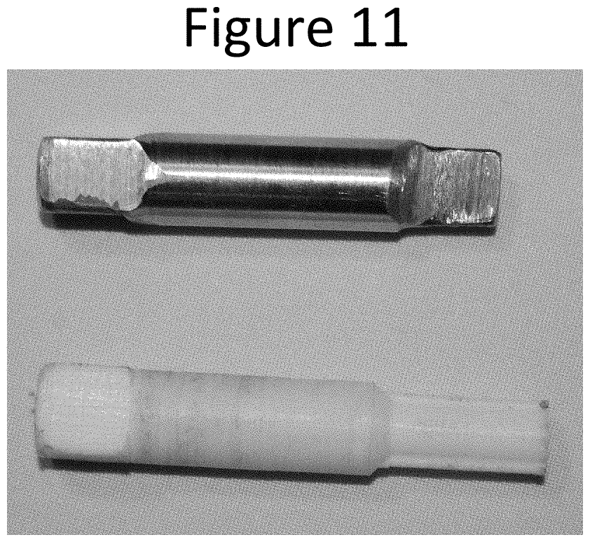

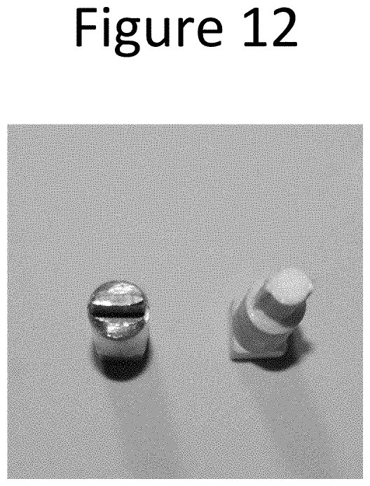

FIGS. 11 and 12 depict non-limiting illustrative embodiments of the drive pins (330, 340) that assist in the operative coupling of the at least one third-party accessory to the KitchenAid mixer (100) of FIG. 1. FIG. 11 depicts a close up latitudinal view of the exemplary illustrative drive pins (330, 340). FIG. 12 depicts a close up longitudinal view of the exemplary illustrative drive pins showing different key styles and arrangements that assist in the operative coupling of the KitchenAid drive hub (110) to the at least one third-party accessory.

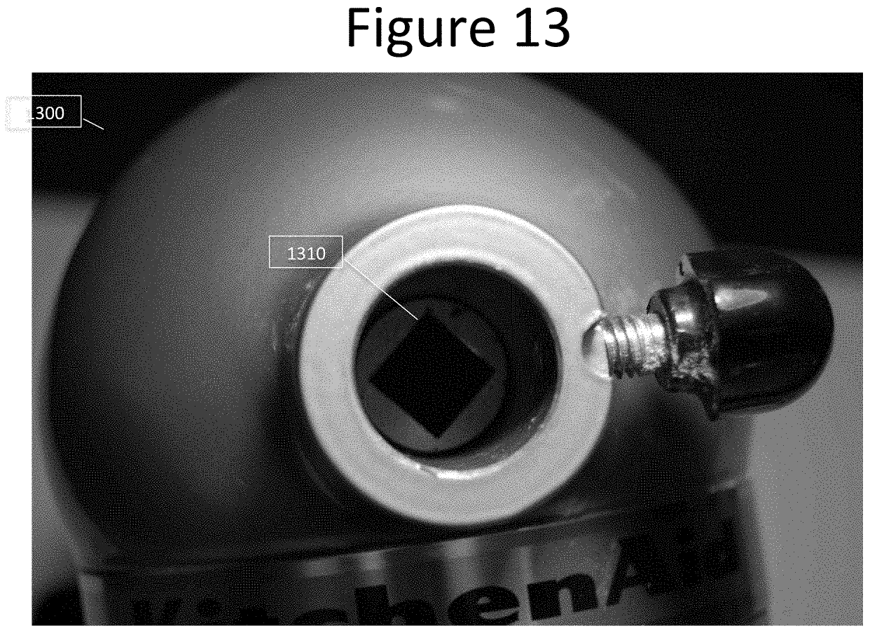

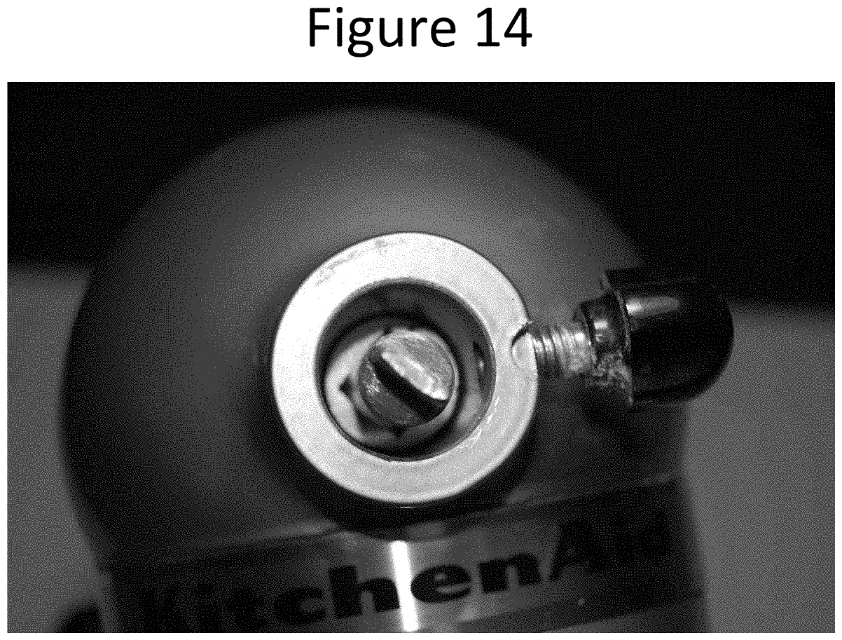

FIGS. 13 and 14 depict a close up view of a non-limiting exemplary illustrative embodiment of a KitchenAid mixer's (1300) drive hub (1310). FIG. 14 depicts a close up view of exemplary drive pin (340) inserted into the KitchenAid mixer drive hub (1310).

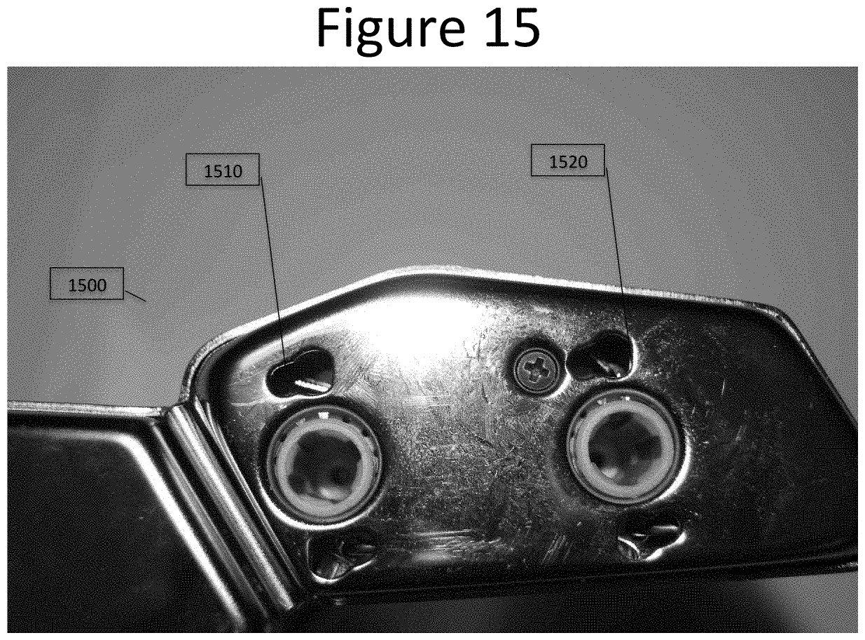

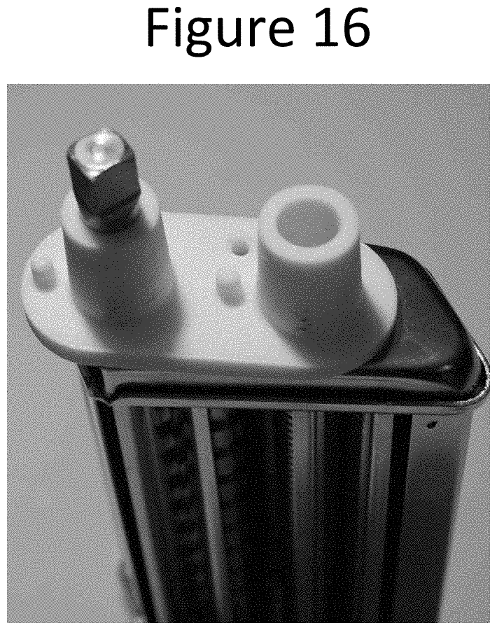

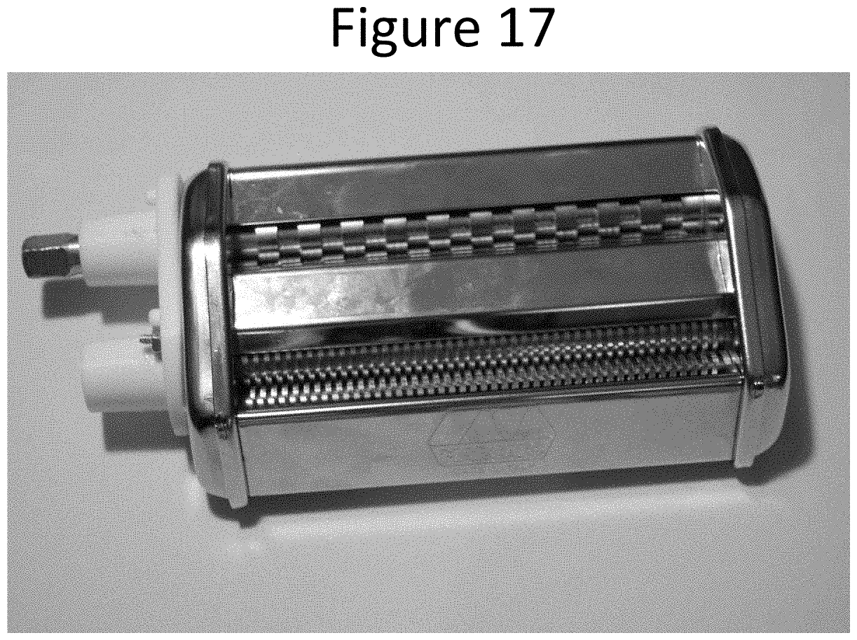

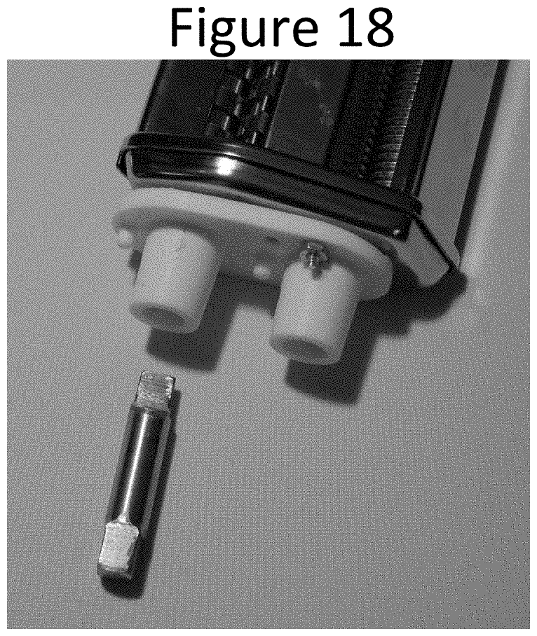

FIGS. 15-18 depict a non-limiting exemplary embodiment of a third-party accessory pasta maker. FIG. 15 depicts a close up view of the drive sockets (1510, 1520) of a common off-the-shelf, commercially available Marcato pasta maker (1500). FIG. 16 depicts an end view of the third-party accessory Marcato pasta maker (1500) mated with exemplary adapter plate (300) Drive pin (340) is inserted through one of the orifices of adapter plate (300) into the Marcato pasta maker (1500) drive socket (1510). It should be easily understood that exemplary drive pin (340) could also be inserted into the secondary orifice of the exemplary adapter plate (300) should the user decide to produce a different style of pasta (fettuccine noodles instead of spaghetti). FIG. 17 is an alternate front view of the third-party accessory Marcato pasta maker with the non-limiting exemplary mating adapter plate (300) and exemplary drive pin (340) attached. FIG. 18 is an alternate side view of the third-party accessory Marcato pasta maker with the non-limiting exemplary mating adapter plate (300) attached and the exemplary drive pin (340) removed.

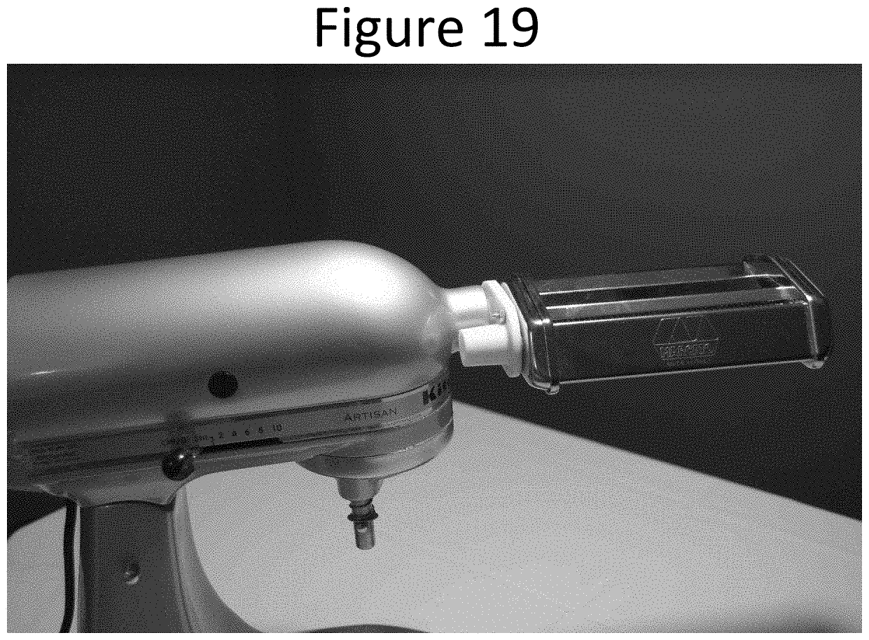

FIG. 19 depicts a non-limiting illustrative embodiment of the third-party accessory Marcato pasta maker with the non-limiting exemplary mating adapter plate (300) attached and the exemplary drive pin (340) inserted operatively coupled to a KitchenAid Mixer's (1300) drive hub (1310). When KitchenAid mixer (1300) is turned on, the non-limiting exemplary third-party Marcato pasta maker (1500) is also operational.

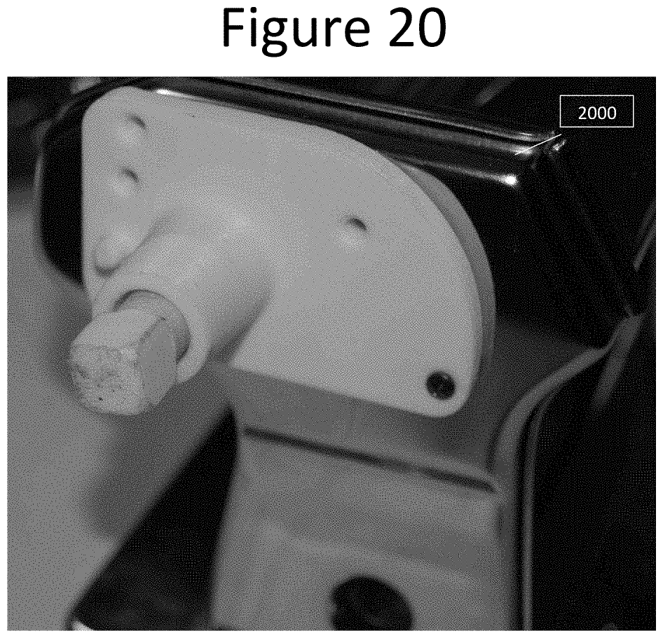

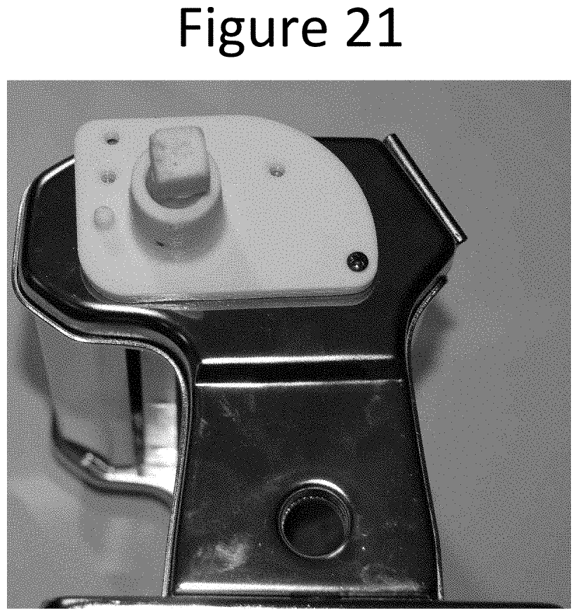

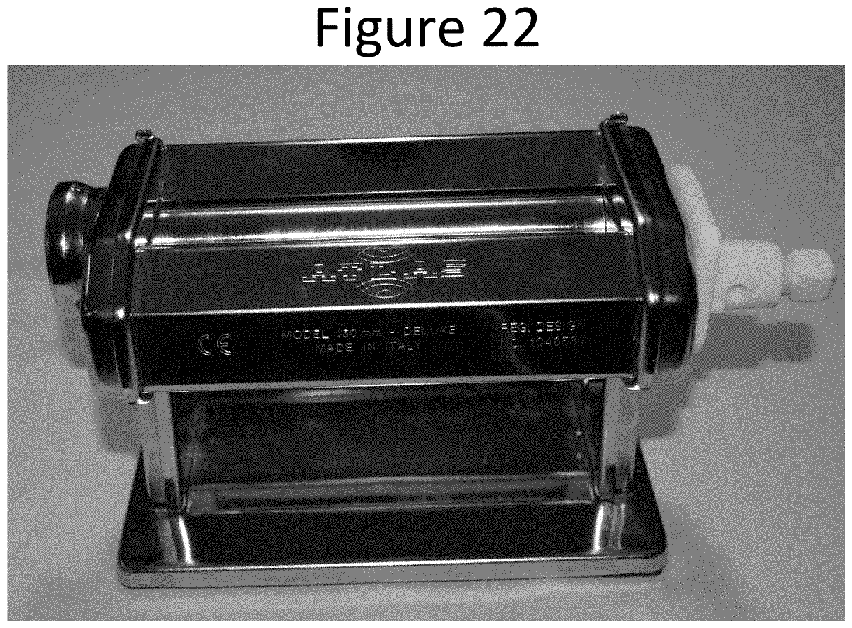

FIG. 20 through 22 depict yet another non-limiting exemplary embodiment of the at least one third-party accessory pasta maker. FIG. 20 depicts a close up side view of a common off-the-shelf, commercially available Atlas pasta maker (2000), with a non-limiting exemplary mating adapter plate (310) of FIG. 3 attached and an associated drive pin (330) inserted through the orifice of the exemplary adapter plate (310) into the drive socket (not shown) of the Atlas pasta maker (2000). FIG. 21 depicts an alternate side view of a common off-the-shelf, commercially available Atlas pasta maker (2000), with a non-limiting exemplary mating adapter plate (310) of FIG. 3 attached and an associated drive pin (330) inserted through the orifice of the exemplary adapter plate (310) into the drive socket of the Atlas pasta maker (2000). FIG. 22 depicts a front view of a common off-the-shelf, commercially available Atlas pasta maker (2000), with a non-limiting exemplary mating adapter plate (310) of FIG. 3 attached and an associated drive pin (330) inserted through the orifice of the exemplary adapter plate (310) into the drive socket of the Atlas pasta maker (2000).

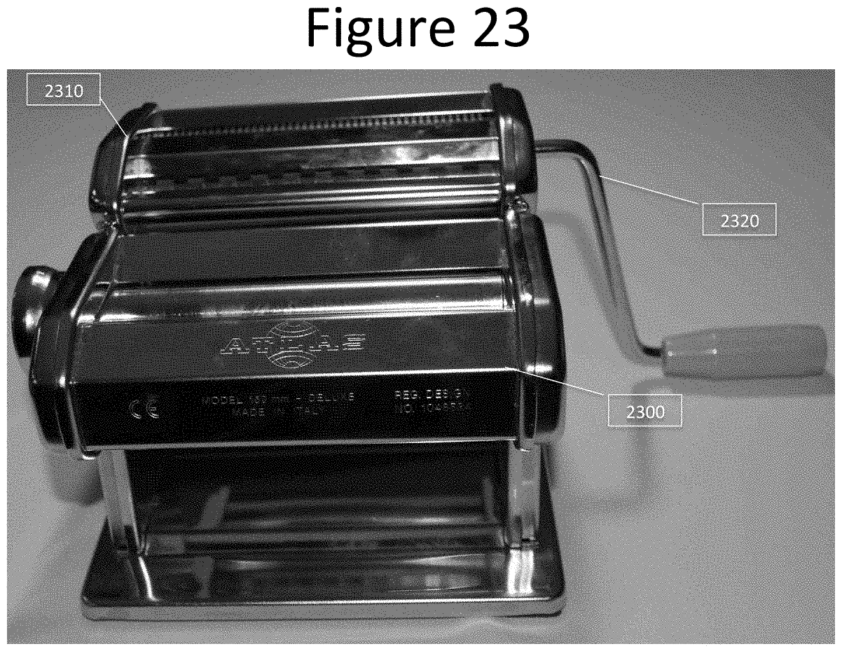

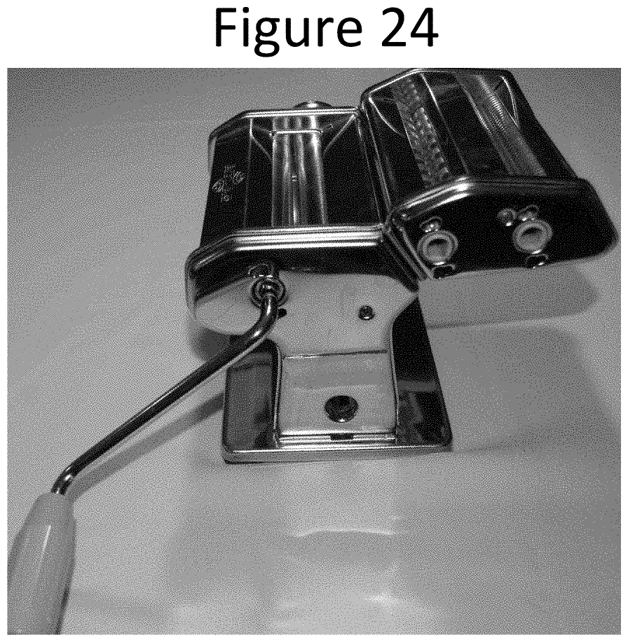

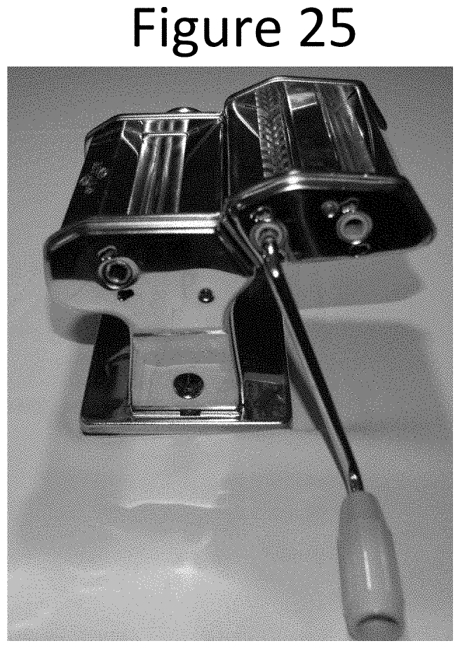

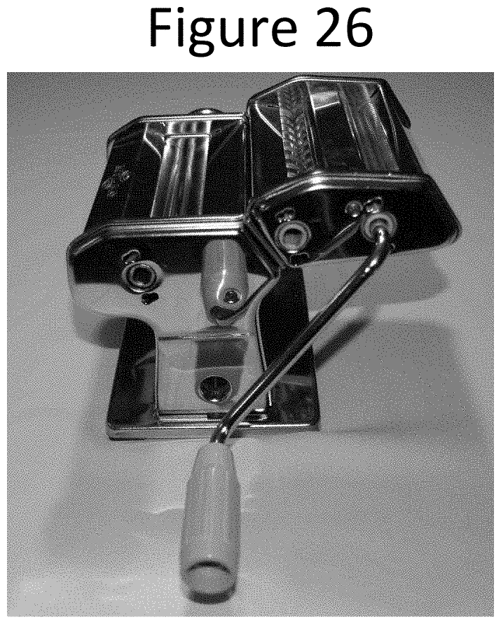

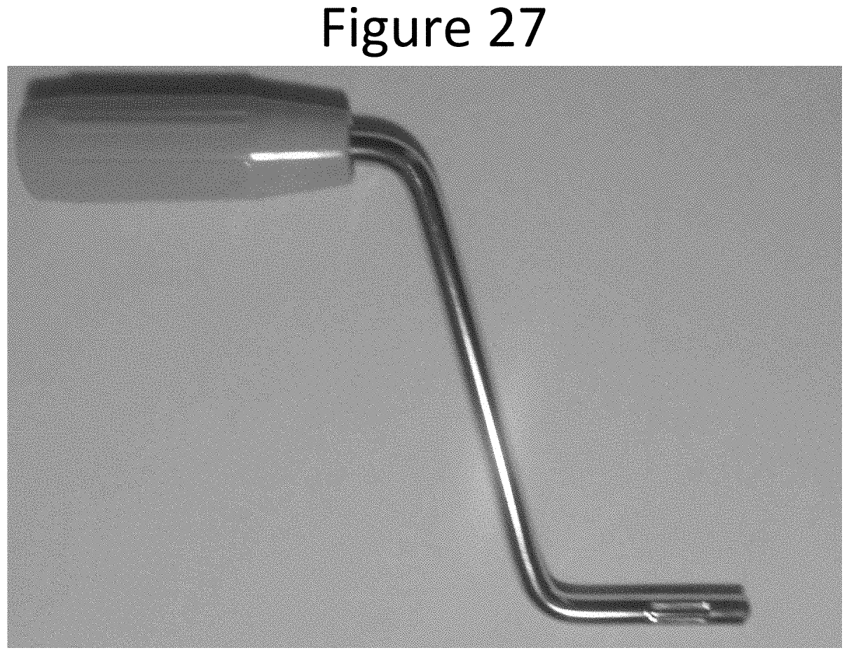

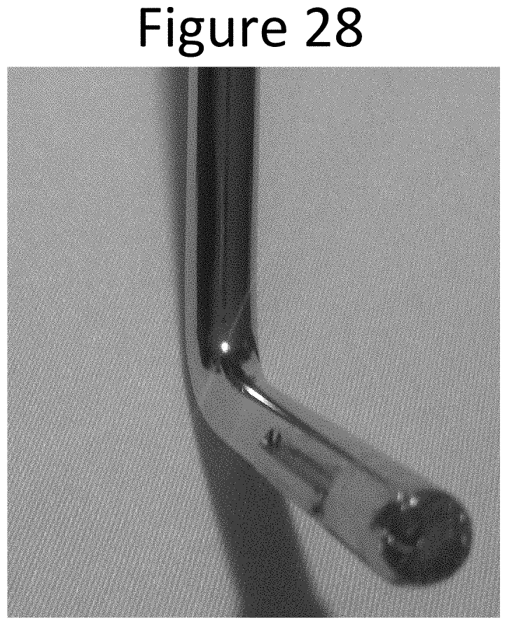

FIGS. 23 through 28 depict a non-limiting exemplary embodiment of the at least two third-party accessory pasta makers. FIG. 23 depicts the non-limiting illustrative third-party common off-the-shelf, commercially available assembled Atlas (2300) and Marcato (2310) pasta makers, together with its supplied hand crank (2320) use to drive the system. FIG. 24 depicts a side view of the non-limiting illustrative third-party common off-the-shelf, commercially available, assembled Atlas (2300) and Marcato (2310) pasta makers of FIG. 23, together with its supplied hand crank (2320) used to drive the system inserted into the drive socket of the Atlas pasta maker (2300). FIG. 25 depicts a side view of the non-limiting illustrative third-party common off-the-shelf, commercially available assembled Atlas (2300) and Marcato (2310) pasta makers of FIG. 23, together with its supplied hand crank (2320) used to drive the system inserted into one of the drive sockets of the Marcato pasta maker (2310). FIG. 26 depicts yet another side view of the non-limiting illustrative third-party common off-the-shelf, commercially available, assembled Atlas (2300) and Marcato (2310) pasta makers of FIG. 23, together with its supplied hand crank (2320) used to drive the system inserted into yet another one of the drive sockets of the Marcato pasta maker (2310). FIG. 27 depicts a close up side view of the illustrative third-party common off-the-shelf, commercially available, assembled Atlas (2300) and Marcato (2310) pasta makers hand crank (2320) of FIG. 23. FIG. 28 depicts a close up end view of FIG. 23's illustrative third-party common off-the-shelf, commercially available, assembled Atlas (2300) and Marcato (2310) pasta makers' hand crank (2320) key design.

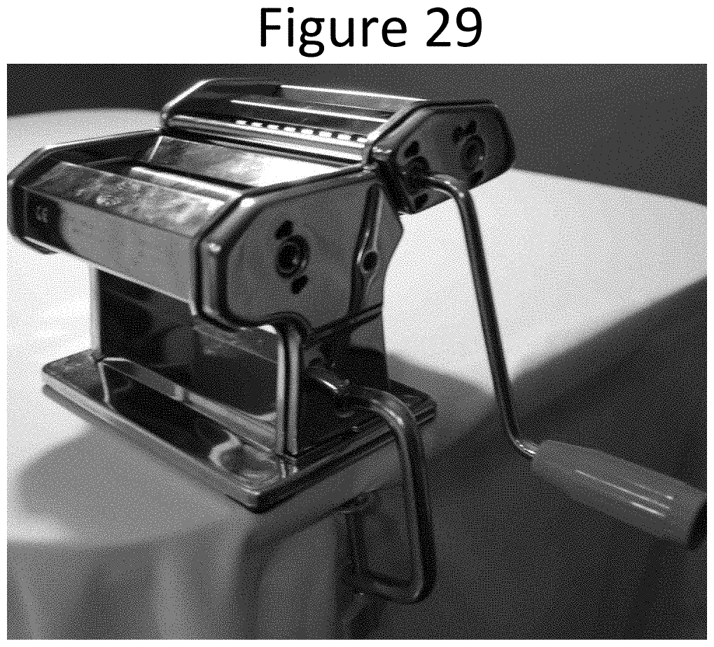

FIG. 29 depicts a side-up end view of FIG. 23's illustrative third-party common off-the-shelf, commercially available, fully assembled Atlas (2300) and Marcato (2310) pasta maker together with its hand crank (2320) mounted to a table using the supplied mounting clamp. As one can easily see in this illustrative example, that the mounting is tentative at best and is highly depends on the size and style of the table or counter top. During normal operations, the mounting clip can come loose or slip, frustrating the user. Furthermore the density and type of dough being used to produce the pasta may require sufficient force with the hand crank, causing the system to move or twist yielding less than desirable results.

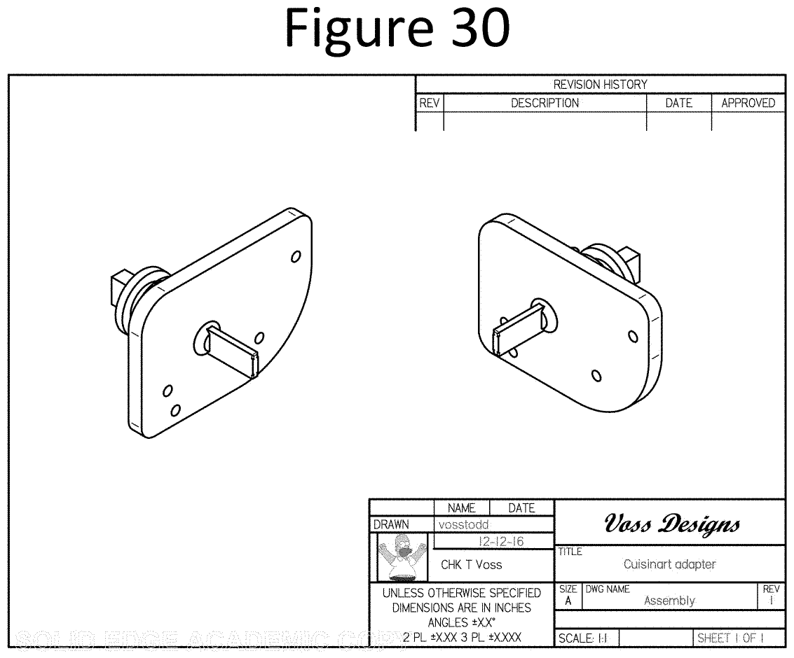

FIG. 30 depicts a non-limiting illustrative embodiment of a mating adapter plate and drive pin assembly that could connect to an alternate drive system such as a common off-the shelf, commercially available Cuisinart Mixer system (not shown).

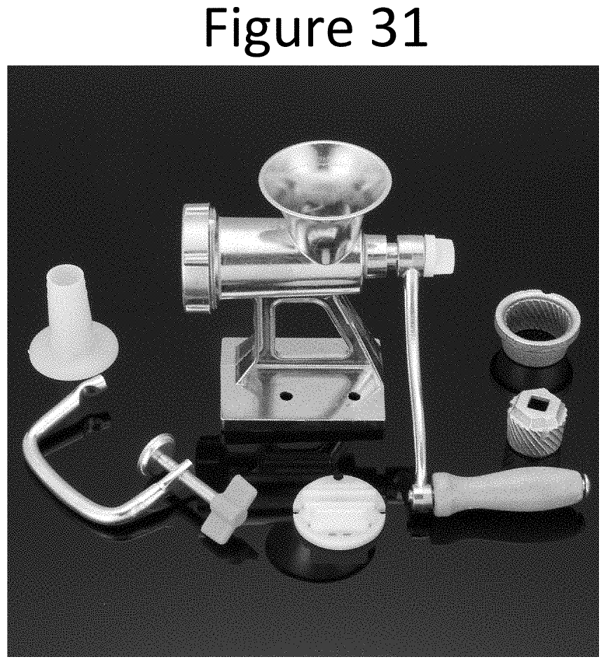

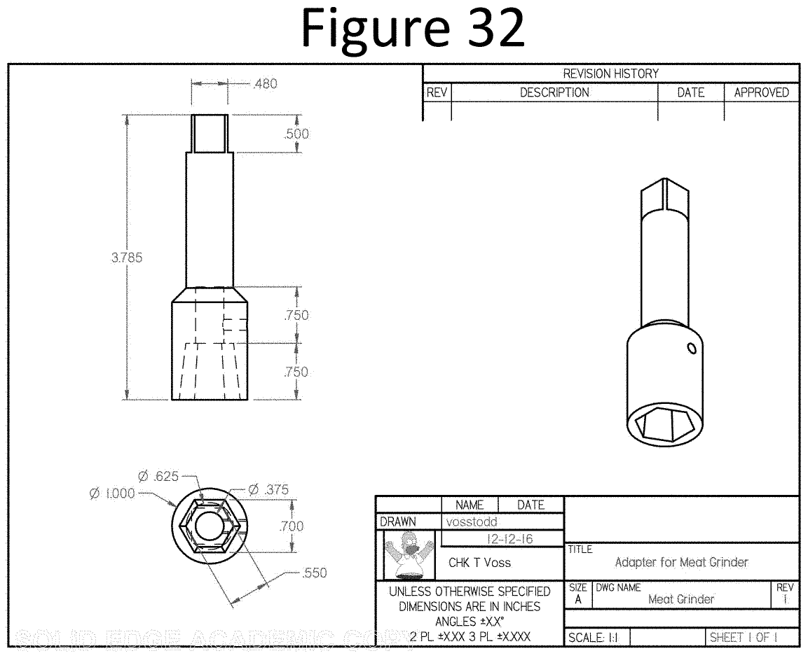

FIG. 31 depicts a non-limiting illustrative embodiment of another common off-the shelf, commercially available third-party meat-grinding device that could be similarly operatively coupled to the aforementioned drive system. FIG. 32 depicts a non-limiting exemplary embodiment of an alternate drive pin assembly that could be used to operate the meat-grinding device of FIG. 31.

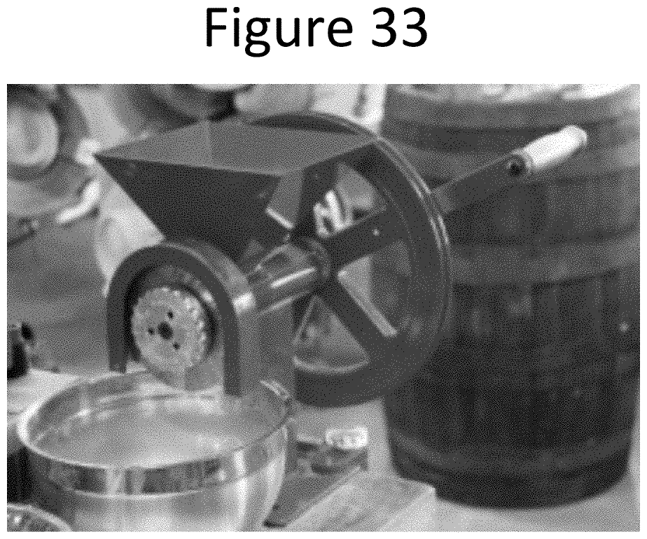

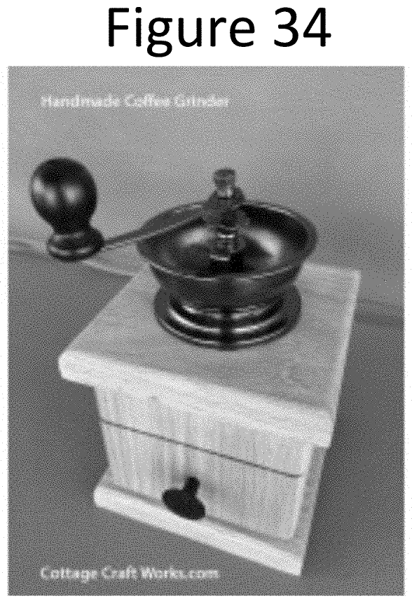

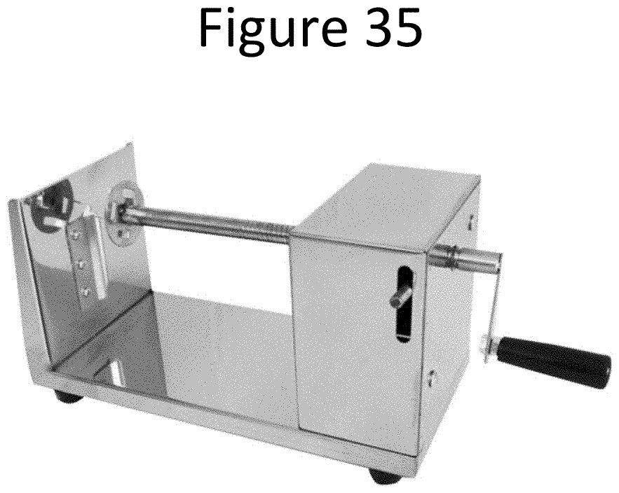

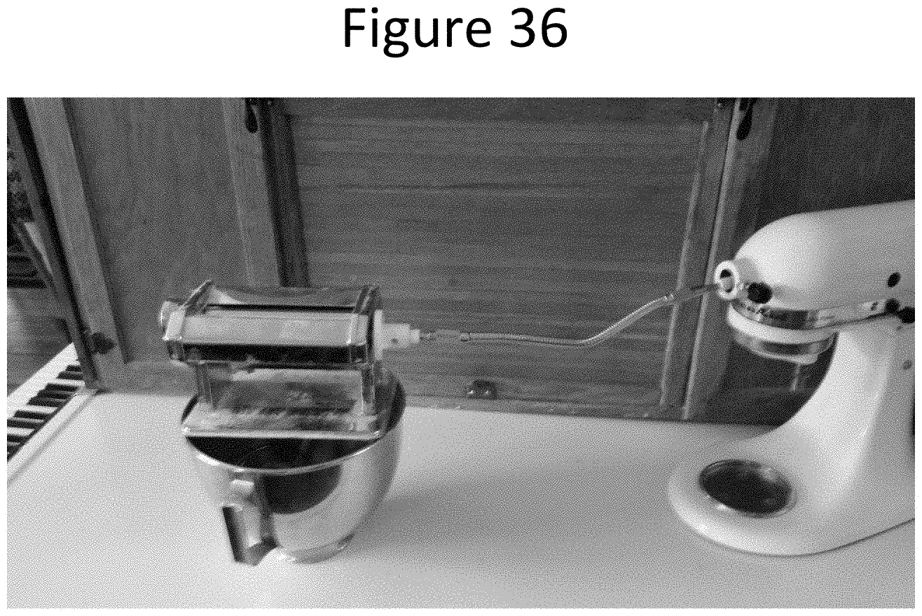

FIGS. 33 through 35 are further non-limiting illustrative embodiments of other common off-the-shelf, commercially available third-party devices that could be similarly operatively coupled to the aforementioned drive system. In yet another non-limiting illustrative embodiment, if the exemplary interoperable third-party device did not lend itself to operatively coupling as depicted in FIG. 19 with the aforementioned drive systems due to weight or other physical or electro-mechanical attribute, the non-limiting illustrative adapter, as depicted in FIG. 36 could be fashioned is such a way as to allow the transfer of torque through an alternate drive system such as a flexible cable/drive pin and/or gear box assembly to modify the speed or direction. One non-limiting illustrative embodiment of the aforementioned gearbox (not shown) may be designed into the adapter mating plates (300, 310, 320) of FIG. 3.

It will be readily understood by those skilled in the art that the technology herein enables additional advantage that may be realized by an organization or customer, as they can now avail themselves of the interoperability between diverse systems, providing them access to solutions not previously available with increased economies. Without these advantages set forth, the total cost of replicating these services by the customer or organization may be cost prohibitive.

It will be readily understood by those persons skilled in the art that the technology herein is susceptible to broad utility and application. Many embodiments and adaptations other than those herein described, as well as many variations, modifications and equivalent arrangements, will be apparent from or reasonably suggested by the foregoing description thereof, without departing from the substance or scope.

While the foregoing illustrates and describes exemplary embodiments, it is to be understood that this disclosure is not limited to the construction disclosed herein. The technology herein can be embodied in other specific forms without departing from its spirit or essential attributes. Thus, while the apparatus has been described in connection with what is presently considered to be the most practical embodiments, other alternatives are possible. Many modifications to the embodiments described can be made without departing from the spirit and scope of the embodiments, as it is intended to be encompassed by the following claims and their legal equivalents.

We claim:

1. A method and apparatus:
that enables the operative coupling between commonly available food processing components and commonly available drive mechanisms;
the apparatus comprising of:
at least one commonly available mixing system;
at least one commonly available attachment for preparing food available from a different manufacturer than the manufacturer of the at least one commonly available mixing system;
an adapter plate to support the at least one commonly available attachment for preparing food to the at least one commonly available mixing system;
a conversion drive mechanism that enables the at least one commonly available mixing system to transfer torque to the at least one commonly available attachment for preparing food;
wherein the apparatus enables the at least one mixing system to be affixed to the at least one commonly available attachment for preparing food, causing the at least one commonly available attachment for preparing food to operate.

2. The apparatus of claim 1:
enables the commonly available attachment for preparing food to operate as though it was utilizing manual power to supply the torque.

3. The apparatus of claim 1:
wherein the at least one commonly available mixing system is manufactured by at least one of KitchenAid and Cuisinart.

4. The apparatus of claim 1:
wherein the at least one commonly available attachment for preparing food is at least one of a pasta maker, a meat grinder, a grain grinder, a coffee grinder, a slicer, a beverage maker.

5. The apparatus of claim 1:
wherein the drive mechanism is a flexible cable

6. A driveshaft assembly comprising:
an elongated cylindrical body having a first and second ends;
the first end of the driveshaft assembly comprising a rectangular head;
the second end of the driveshaft assembly comprising a portion that is co-axial with the first end rectangular head,
the first end rectangular head being dimensioned and structured to be accepted into and retained within a power head of an electric mixer;
the second end being of a different design from the first end and being dimensioned and structured to be accepted into and retained within a drive receptacle of a food preparation device;
the first end rectangular head defines four side rectangular surfaces and a rectangular end surface, and
the second end cylindrical portion is further designed and keyed to cause the food preparation device to become operable when inserted into the drive receptacle of the food preparation device and the electric mixer becomes operable,
wherein with the first end of the driveshaft assembly is inserted and retained into the power head of the aforementioned electric mixer, and
the second end of the driveshaft assembly is inserted into the food preparation device,
the driveshaft rotates about its center axis enabling the transference of sufficient torque from the electric mixer power head to the food preparation device as the power head of the electric mixer operates, enabling the mating and operation of previously disparate incompatible electric mixers and food preparation devices.

7. The driveshaft assembly of claim 6 wherein:
the second end of the cylindrical portion having a design that is keyed to match the drive receptacle of a food preparation device that is manufactured by a different manufacturer than that of the electric mixer.

8. The driveshaft assembly of claim 6 wherein:
the second end has a cylindrical portion, further having at least one longitudinally-extending projection disposed thereon, the longitudinally-extending projection being parallel to the axis of the second end cylindrical portion.

9. The driveshaft assembly of claim 6 wherein:
the second end cylindrical portion further having a radius that is smaller than the radius of the body of the driveshaft assembly.

10. The driveshaft assembly of claim 6 wherein:
the second end cylindrical portion further having a radius that is larger than the radius of the body of the driveshaft assembly.

12. The driveshaft assembly of claim 6 wherein:
the first end four side rectangular surfaces having lengths in the axial direction of less than two centimeters.

12. The driveshaft assembly of claim 8 wherein:
the second end longitudinally-extended projection has a length in the axial direction of more than one centimeter.

13. The driveshaft assembly of claim 6 wherein:
the second end has two larger rectangular surfaces, two smaller rectangular surfaces, and a rectangular end surface.

14. The driveshaft assembly of claim 13 wherein:
the second end two larger rectangular surfaces have a dimension of at least one centimeter in length in the axial direction.

15. The driveshaft assembly of claim 13 wherein:
the second end two smaller rectangular surfaces have a dimension of at least 1 millimeter in width.

16. The driveshaft assembly of claim 13 wherein:
the second end rectangular end surface has a dimension of at least 1 centimeter in width.

17. The assembly of claim 6 further comprising:
an adapter plate structured and designed to mate to the food preparation device and provide access to the food preparation device's drive socket and the electric mixer's power head,
the adapter being further designed to house the driveshaft that mates the food preparation device and the electric mixer,
the adapter being further designed to help support and retain the driveshaft coupled with the power head of the electric mixer and the food preparation device while each device is operational.

18. The adapter plate of claim 17:
being furthered designed to have multiple positions in the event that the food preparation device has multiple drive sockets available for the preparation of different foods.

19. The adapter plate of claim 17:
being furthered designed to have a flat surface with mounting holes to assist in the attachment of the adapter plate to the food preparation device, and
has at least one cylindrical protrusion that is perpendicular to the flat surface used to house the driveshaft assembly of claim 6.

20. The adapter plate of claim 17:
being furthered designed to have the cylindrical protrusion to be at least 2 centimeters in length in the perpendicular direction to the flat surface.

21. The adapter plate of claim 17:
being further designed to have the cylindrical protrusion have an outer diameter of at least 2 centimeters and an inner diameter of at least 1 centimeter.

22. The adapter plate of claim 17:
being further designed to have the cylindrical protrusion acts as the housing for a flexible driveshaft.

23. The adapter plate of claim 17:
being further designed to house a gear assembly to at least do one of increasing, decreasing, and reversing the rotation of the driveshaft when the electric mixer power head drive mechanism is rotating.
